(19) United States
(12) Patent Application Publication
(10) Pub. No.: US 2009/0038297 A1
(43) Pub. Date: Feb. 12, 2009

(54) Ceramic Catalyst for NOx Oxidation and NOx Conversion in Emission Control Systems

(75) Inventors: Balakrishnan Nair, Salt Lake City, UT (US); Sai Bhavaraju, Salt Lake City, UT (US); Jesse Nachlas, Salt Lake City, UT (US); James Steppan, Salt Lake City, UT (US)

Correspondence Address: CERAMATEC, INC., 2425 SOUTH 900 WEST, SALT LAKE CITY, UT, 84119, US

(73) Assignee: CERAMATEC , Inc., Salt Lake City, UT (US)

(21) Appl. No.: 11/574,502

(22) PCT Filed: Sep. 1, 2005
(86) PCT No.: PCT/US2005/031528

§ 371 Date: Feb. 28, 2007

Related U.S. Application Data
(60) Provisional application No. 60/606,307, filed on Sep. 1, 2004.

(51) Int. Cl. F01N 3/20; B01J 23/30; B01J 23/34; B01J 23/46; B01J 23/56; B01J 23/74

(52) U.S. Cl. 60/299; 502/305; 502/324; 502/325; 502/326; 60/274

(57) ABSTRACT

Ceramic catalytic compositions, systems, and methods for oxidizing, converting and/or removing NOₓgas species present in gas streams such as exhaust gases are provided. The catalysts of the invention oxidize the nitrogen monoxide (NO) in gas streams to nitrogen dioxide (NO₂), which may be adsorbed by a metal oxide or other NO₂ adsorber. Catalysts suitable for use in systems of the present invention include ceramic oxides, mixtures of ceramic oxides, complex ceramic oxides, and mixtures of complex ceramic oxides. Such catalysts are shown herein to successfully achieve an NO-NO₂ equilibrium gas composition at temperatures as low as 275° C. In addition, by using the catalyst with an NO₂ adsorber, greater than 95% removal of combined NO and NO₂ from the gas stream has been successfully demonstrated. Further, specific strategies have been identified to regenerate the catalyst system and restore performance after prolonged exposure to species such as sulfur dioxide (SO₂).

### RELATED APPLICATIONS

This application is related to and claims the benefit of U.S. Provisional Patent Application Ser. No. 60/606,307, of Balakrishnan Nair, Sai Bhavaraju, and Jesse Nachlas filed on Sep. 1, 2004, and entitled “CERAMIC CATALYST FOR NOx OXIDATION AND NOx CONVERSION IN EMISSION CONTROL SYSTEMS. Application Ser. No. 60/606,307 is incorporated herein by this reference in its entirety.

### FIELD OF THE INVENTION

The present invention relates in general to the removal and/or reduction of oxides of nitrogen (NOₓ) from exhaust gases generated by stationary or mobile sources that produce these gas species.

### BACKGROUND OF THE INVENTION

Exhaust gases produced by the combustion of hydrocarbon fuels are a complex mixture a variety of oxide gases including NOₓ species. These nitrogen oxide gases are precursors of ozone and otherwise contribute to atmospheric pollution. As a result, the government has initiated regulation of NOₓ emissions produced by vehicles that will go into effect in the near future.

As a result, much attention has been focused on systems and methods for removing such gases from gas streams such as exhaust streams produced by devices that combust carbonaceous fuels. One difficulty faced is that such exhaust streams generally include a high concentration of NO relative to NO₂ concentrations. NO₂ is more easily removed from gas streams. This has driven attention to technologies that convert NO to NO₂ in order to simplify adsorption of the gas. Conventional NOₓ adsorber systems include a platinum group metal reaction catalyst which oxidizes NO to NO₂ and an adsorbent material which adsorbs the NO₂.

Platinum-group metal catalysts have long been the catalysts of choice in such catalyst-based NOₓ gas removal systems. A whole range of platinum group metals, including ruthenium metal, is known to operate acceptably as the oxidizing catalyst in such systems. The NO₂ adsorbing material is typically an alkali or an alkaline earth oxide. Such catalysts are regarded as costly, however. Their cost has driven use of a relatively low load of catalyst into catalytic systems, resulting in efficiency loss in such systems. In addition, platinum-group metal catalysts may be poisoned by exposure to other exhaust gases including sulfur dioxide.

Thus, it would be an improvement in the art to provide catalysts and NOₓ adsorbing systems using non-metallic catalysts, including ceramic catalysts that oxidize NO to NO₂. Such catalysts and NOₓ adsorbing systems incorporating them are provided herein.

### BRIEF SUMMARY OF THE INVENTION

The present invention is directed to a catalyst system for oxidizing, converting and/or removing NOₓ gas species present in exhaust gases from mobile and stationary sources. The principle is that the catalyst oxidizes the nitrogen monoxide (NO) present in exhaust gases to nitrogen dioxide (NO₂), which is subsequently absorbed by a metal oxide or other NO₂ adsorber. Catalysts suitable for use in the catalyst systems of the present invention include ceramic oxides, mixtures of ceramic oxides, complex ceramic oxides, and mixtures of complex ceramic oxides. Such types of catalysts are shown herein to successfully achieve an NO-NO₂ equilibrium gas composition at temperatures as low as 275° C. In addition, by using the catalyst in combination with an NO₂ adsorber, greater than 95% removal of combined NO and NO₂ from the gas stream has been successfully demonstrated. Further, specific strategies have been identified to regenerate the catalyst system and restore performance after prolonged exposure to species such as sulfur dioxide (SO₂).

The present invention may thus overcome some problems commonly associated with the practical application of NOₓ adsorbers that have been encountered with conventional technologies. One such issue is that the catalysts of the present invention are ceramic in nature and often have a cost lower than that of the noble metal catalysts commonly used. The relatively high cost of these traditional noble metal catalysts has often resulted in low catalyst loading in catalyst systems. Low catalyst loading, in turn, often reduces the effectiveness of the systems. The ceramic catalyst systems of the present invention could enable more cost-efficient catalyst systems and/or systems with a higher load of catalyst, thus potentially providing better NOₓ conversion and adsorption.

It is also anticipated that some embodiments of the ceramic catalysts of the present invention may also function effectively to remove NOₓ over a wide temperature range (200-450° C.). More specifically, the use of ruthenium dioxide and other ceramic catalysts of the present invention offers the possibility of high-temperature resistance, and potentially resistance to aging. It is well known in the field that ceramic materials, especially oxides, have better high temperature stability in the upper temperature ranges experienced in engines than metallic materials. The ceramic nature of the catalysts may also impart resistance to action from fuel ingredients during departures from normal thermal conditions (referred to herein as “thermal excursions”). Indeed, the ruthenium oxide and other ceramic catalyst materials of the present invention may offer the advantage of a wider range of temperature performance. Some such catalysts may be able to perform to reduce NO to N₂ and O₂ in the range of from about 350-400° C.

Other advantages and aspects of the present invention will become apparent upon reading the following description of the drawings and detailed description of the invention. These and other features and advantages of the present invention will become more fully apparent from the following figures, description, and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a schematic view of a ceramic catalyst of the present invention used in a packed powder configuration for purifying NOₓ-containing gas;

FIG. 2 is a schematic view of a ceramic catalyst of the present invention used in a mixed catalyst and adsorber packed powder configuration for purifying NOₓ-containing gas;

FIG. 3 is a photograph of a commercially-available cordierite honeycomb structure coated with a ruthenium oxide ceramic catalyst of the present invention;

FIG. 4 is a chart illustrating the oxidation performance of the ruthenium oxide-coated honeycomb structure of FIG. 3 in oxidizing NO to NO₂, as discussed in Example 1, demonstrating establishment of equilibrium at temperatures as low as 275° C. at space velocities as high as 17,000/hr;

FIG. 5 is a chart illustrating the performance of ruthenium oxide packed powder in oxidizing NO to NO₂ a variety of gas concentrations over a range of temperatures;

FIG. 6 is a chart illustrating the NO to NO₂ oxidation performance of various ceramic oxide catalysts of the present invention as a function of temperature, showing that at this space velocity (17,000/hr), ruthenium oxide, bismuth ruthenium oxide and 90 wt % MnO₂/10 wt % WO₃ can establish equilibrium at a temperatures at least as low as 275° C., 350° C. and 400° C. respectively;

FIG. 7 is a chart demonstrating that the NO to NO₂ conversion efficiency of bismuth ruthenium oxide at lower temperatures can be improved by increasing the residence time (lowering the space velocity);

FIG. 8 is a chart illustrating NOₓ removal by a powder mixture of ruthenium oxide and barium oxide as a function of time, showing highly efficient NOₓ removal as a function of time;

FIG. 9 is a chart illustrating time-averaged NOₓ removal efficiencies by a powder mixture of ruthenium oxide and barium oxide as a function of temperature, showing highly efficient removal of NOₓ removal over a temperature range of 250-400° C.;

FIG. 10 is a chart illustrating time-averaged NOₓ removal efficiencies observed from a powder mixture of bismuth ruthenium oxide and barium oxide as a function of temperature, showing highly efficient removal of NOₓ over a temperature range of from about 250° C. to about 400° C.; and

FIG. 11 is a chart illustrating that performance of the ceramic catalysts of the present invention can be restored through a mild desulfation process involving exposure of the catalyst to reducing conditions and fuel rich conditions, as discussed in Example 4.

### DETAILED DESCRIPTION OF THE INVENTION

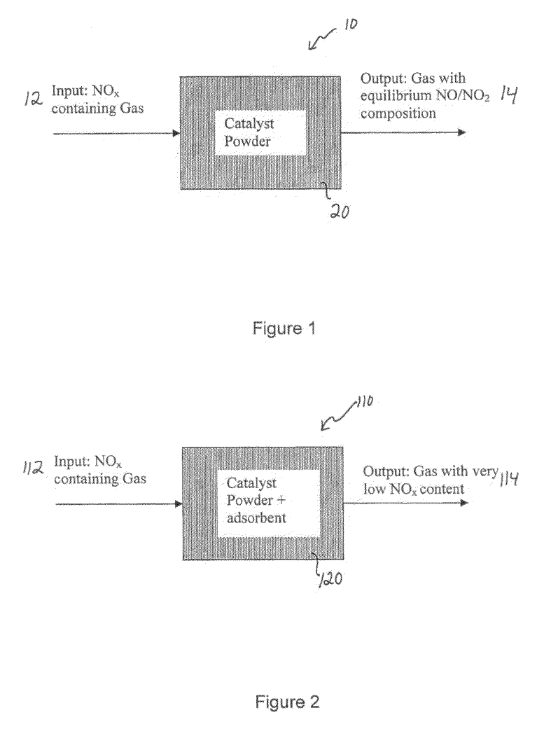

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the ceramic catalyst for NOₓ oxidation and NOₓ conversion in emission control systems of the present invention, as represented in FIGS. 1-11, is not intended to limit the scope of the invention, as claimed, but is merely representative of presently preferred embodiments of the invention.

The present invention first provides catalysts for oxidizing nitrogen monoxide (NO) to nitrogen dioxide (NO₂). The catalysts of the present invention are generally suitable for establishing an equilibrium NOₓ concentration at temperatures exceeding about 200° C. In some instances, the catalysts of the present invention are capable of establishing such an equilibrium at temperatures exceeding 275° C. The catalysts of the present invention may be generally described as complex oxides containing ruthenium. In some instances, these complex oxides have the formula A₂Ru₂O₇. A is generally a transition metal capable of being in a 2+ valence state. Thus, in this general equation, A may be selected from the group consisting of Mg (magnesium), Ca (calcium), Sr (strontium), Ba (barium), Mn (manganese), Ni (nickel), Fe (iron), Co (cobalt), Cu (copper), Ti (titanium), Cr (chromium), Zn (zinc), Nb (niobium), Eu (europium), Ce (cerium), Gd (gadolinium), and Sm (samarium). Other suitable transition metals will be understood to one of ordinary skill in the art. Another catalyst of the present invention is a mixture of manganese dioxide (MnO₂) and tungsten oxide (WO₃) described in greater detail below.

A first such catalyst material is ruthenium dioxide (RuO₂). Ruthenium oxide may be produced by heating the platinum group metal ruthenium in oxygen. Ruthenium dioxide is generally found as a dark-colored powder or crystalline solid. A next ceramic catalyst material within the scope of the present invention is bismuth ruthenate (Bi₂Ru₂O₇). Yet another ceramic catalyst material of the present invention is mixture of manganese dioxide (MnO₂) and tungsten oxide (WO₃). A wide range of ratios of MnO₂ and WO₃ may be used in this mixture catalyst. In some instances, mixtures include from about 50% MnO₂ to about 90% MnO₂ and thus from about 50% WO₃ to about 10% WO₃. In one embodiment, the catalyst includes approximately 80% MnO₂ and approximately 20% WO₃.

According to the present invention, the catalysts discussed above (RuO₂, Bi₂Ru₂O₇, and MNO₂/WO₃) may be used alone, in mixtures, and in mixtures with known catalysts including, but not limited to, platinum-group metals.

One embodiment of the present invention is represented in FIG. 1. More specifically, FIG. 1 illustrates a system 10 for converting a gas mixture with a non-equilibrium NO to NO₂ composition 12 to a gas mixture with an equilibrium NO to NO₂ composition 14 by exposure to a powder bed 20 composed of or containing the catalyst of the present invention. This embodiment illustrates the function of the catalysts of the present invention in that operation simply involves exposure of a NOₓ-containing gas to the catalyst. For commercial applications, however, different structures (discussed in greater detail below) are used to reduce back pressure and accommodate higher flow rates such as those typical of flows of exhaust gases produced by hydrocarbon-fueled engines.

It should be noted that emissions of NO may be produced in a wide variety of ways, including, but not limited to, the combustion of fuels such as, but not limited to, diesel fuel, other petroleum-based fuels, natural gas, coal, other carbonaceous fuels, and a variety of chemical processes. The catalysts, systems, and methods of the present invention are suitable for use with flows of NOₓ gases produced by all such sources.

FIG. 2 illustrates a second application of the catalysts of the present invention: a combined catalyst/adsorber system 110. In this system, a mixture of a catalyst of the present invention is provided as a constituent of a mixture of the catalyst and a NO₂ adsorbent material placed in the powder bed i20. This configuration is more common in commercial applications and thus was tested for its efficacy in NOₓ removal. An input flow 112 is exposed to the powder bed 120, and exits as an exit flow 114. The NOₓ adsorbers used with the catalysts of the present invention include, without limitation, alkali and alkaline earth metal oxides, such as barium oxide. Such compounds have been used for the removal of NOₓ from exhaust gases formed by combustion of diesel, petroleum fuels, natural gas, coal and other carbonaceous fuels. One of ordinary skill in the art would be aware of other suitable compositions for use as a NOₓ adsorber.

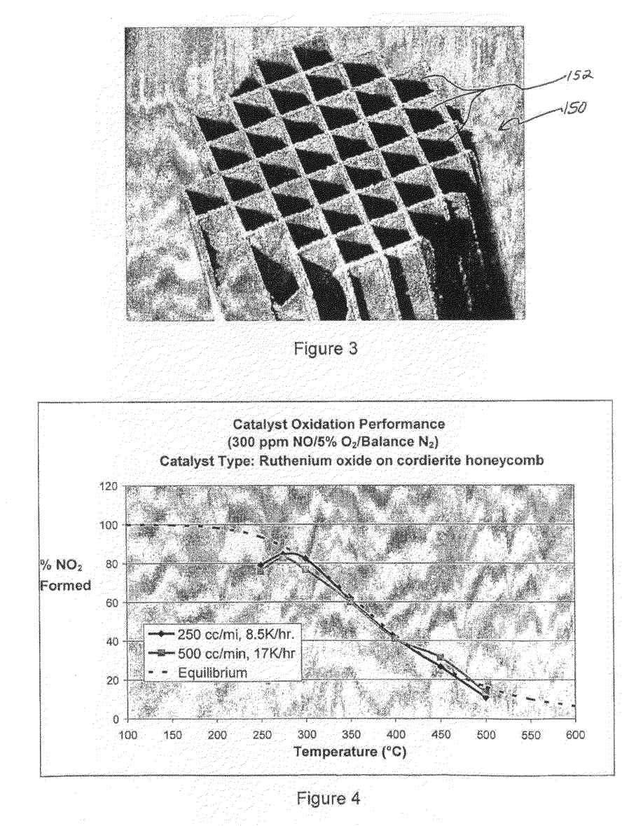

Referring next to FIG. 3, an embodiment of an emission control system incorporating catalyst systems of the present invention is shown. In this system, the catalyst is deposited on a ceramic support 150. The ceramic support 150 has a three-dimensional structure including channels 152 to allow it to be used with exhaust flows having high space velocities in order to assure low back pressure. The honeycomb-shaped structure 150 depicted in FIG. 3 is commonly used in currently-available catalytic converters with other catalytic compounds. It would be suitable for use with the novel ceramic catalysts of the present invention.

Alternatively, however, a wide variety of other structures are suitable for use with the catalysts of the present invention. As shown above, in some low-pressure/low-volume applications, a simple bed of catalyst may suffice. In others with higher flow rates or pressures, a support that allows gas flow and increases the surface area of the catalyst is desirable. The honeycomb structure 150 of FIG. 3 is one structure that accomplishes this task. One of ordinary skill in the art comprehends, however, that a vast variety of structures can similarly serve to provide an increased surface area. Indeed, structures ranging from a tube or array of tubes would increase surface area, as would use of a powdered or pelleted substrate such γ-alumina powders, γ-alumina pellets, ceria powders, ceria pellets, zirconia powders, and zirconia pellets. Other similar substrate materials will be known to one of ordinary skill in the art.

Similarly, the ceramic catalyst materials of the present invention may be loaded onto their support in a variety of ways, including, but not limited to, as a thin film, a coating, or as micron-sized or nano-sized particles. The catalyst may be loaded onto the support alone, at the same time as the NOₓ-adsorbing compound, or stepwise, with the catalyst being loaded before or after loading of the NOₓ-adsorbing compound. The catalyst material may be loaded onto the support using liquid-based system (including application methods such as dip-coating or spraying), solution-based application, vapor-based application, or sol-gel-based routes onto the chosen support.

It is understood that although the preferred embodiments shown here are based on packed powders or catalysts deposited on ceramic supports, the concepts that enable the catalyst and catalyst/adsorber system to perform effectively also be extended to other designs. Such designs could include, but are not limited to these catalysts deposited on high surface area ceramic, metal or polymer materials and configurations where the catalyst and adsorber may be physically separated but used in conduction. In addition, it is expected that microstructure and morphology of these catalysts can be varied by different processing routes, but these variations in microstructure/morphology without changing the compositions specified by this invention will still be covered by this invention.

### EXAMPLES

### Example 1

In a first example, an emission control system was prepared using a commercial cordierite honeycomb structure (reference number 150 of FIG. 3) as the catalyst substrate. The cordierite honeycomb 150 was first machined to approximate dimensions of approximately 0.8 cm in diameter and about 1 cm in length. The structure 150 was then dipped in a solution of ruthenium chloride and allowed to dry. The honeycomb structure 150, now coated with ruthenium chloride, was then fired in air at a high temperature of between about 500° C. to about 800° C. to convert the ruthenium chloride to ruthenium oxide. The resulting structure 150 is shown in FIG. 3.

Following these initial preparation steps, the honeycomb structure 150 was then inserted into a stainless steel tube having a ⅜″ diameter to act as a housing. This tube was then inserted into a furnace that allowed the temperature to be varied. Gases were mixed together using a four-channel mass flow controller system to provide a flow of gas with a controllably-variable NOₓ concentration.

The gas stream produced above was next routed through the housing and emission control system. Measurements were made of the gas constituents exiting the system, and results from this test were recorded. The results of this test are shown in FIG. 4. FIG. 4 illustrates that the catalyst facilitates the achievement of NO-NO₂ equilibrium at temperatures as low as about 275° C., and at space velocities as high as about 17,000/hr.

### Example 2

In a second example of the emission control systems of the present invention, a second catalyst system was fabricated. In this system, a ⅜″ diameter stainless steel tube was used as the system housing. The housing had a gas entry end and a gas exit end with corresponding entry and exit apertures. The gas exit end of the tubular housing was provided with a nickel mesh plug. This plug was installed by press-fitting the plug into the gas exit end of the tube. Following installation of the plug, a quantity of ruthenium oxide powder (approximately about 0.2 to about 0.6 grams of ruthenium oxide powder) was inserted into the stainless steel tube and allowed to settle against the gas exit end of the tube. The powder was then lightly compacted using a rod inserted into the housing. This acted to press the powder against the surface of the nickel mesh plug.

Following assembly, the tubular housing was inserted into a furnace that allowed the temperature to be varied described in Example 1 above. Also as above, gases were mixed together using a four channel mass flow controller system that enabled changing the NOₓ concentration in the gas stream. The gas stream was routed through the emission control system, and the outflow gases were characterized. Results from this test are shown in FIG. 5.

FIG. 5 illustrates that the RuO₂ catalyst facilitates the achievement of a high conversion of NO to NO₂ equilibrium over a wide range of NOₓ concentrations. Further, this Example illustrates that this equilibrium may be achieved at temperatures as low as about 250° C. and at space velocities as high as about 8,500/hr.

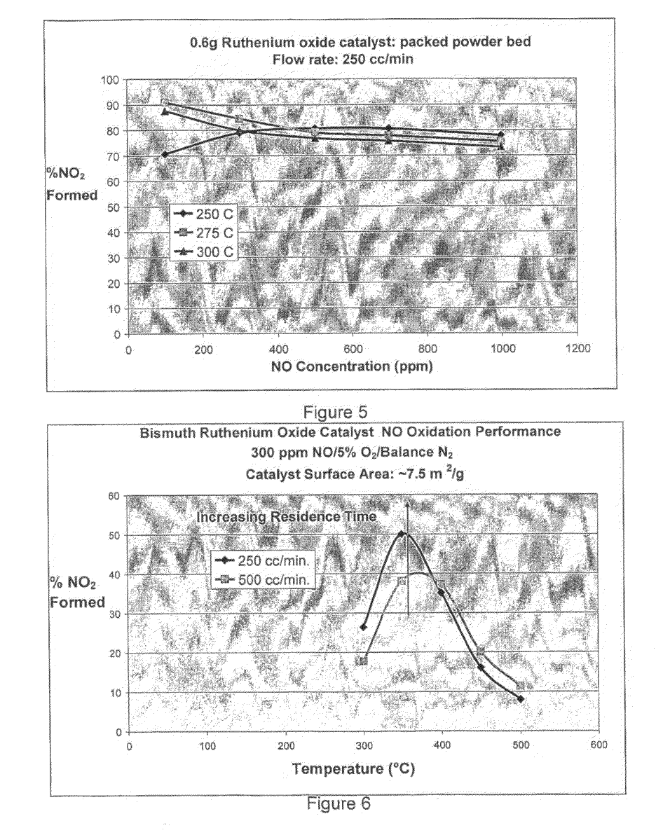

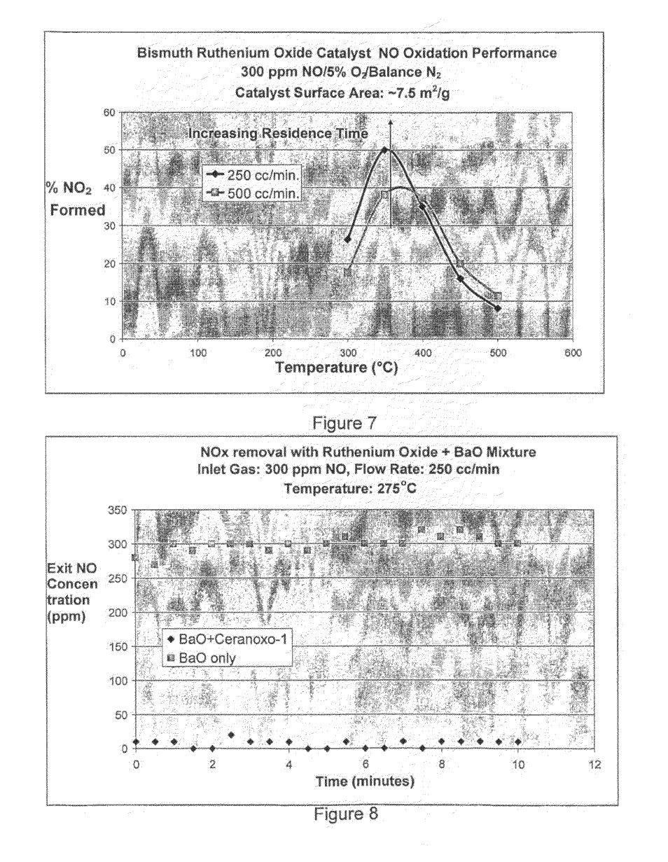

FIG. 6 illustrates the NO to NO₂ oxidation performance of various ceramic oxide catalysts as a function of temperature. At this space velocity (8500/hr), ruthenium oxide, bismuth ruthenium oxide, and 90 wt % MnO₂/10 wt % WO₃ can establish NO/NO₂ equilibrium at a temperatures at least as low as about 275° C., 350° C., and 400° C., respectively. As illustrated by FIG. 7, it is possible to improve the conversion efficiencies of ultra low-cost materials such as bismuth ruthenium oxide by going to lower space velocities/higher residence times.

### Example 3

A next catalyst system according to the present invention was fabricated by using a ⅜″ diameter stainless steel tube as the system housing. As in Example 2 above, the housing tube had a gas entry end and a gas exit end with appropriate entry and exit apertures. At the gas exit end of the housing tube, a nickel mesh plug was installed by press-fitting the plug into the end of the tube. Next, an amount of from about 0.2 to about 0.6 grams of ruthenium oxide or bismuth ruthenium oxide powder was mixed uniformly with about 0.2 g of barium oxide. This powder mixture was then inserted into the stainless steel tube housing. The powder mixture was then lightly compacted into place using a rod inserted into the housing. Compaction pressed the powder against the surface of the nickel mesh plug.

As previously discussed above, the resulting system was then inserted into a furnace that allowed the temperature to be varied. Also as above, gases were mixed together using a four channel mass flow controller system that enabled changing the NOₓ concentration in the gas stream.

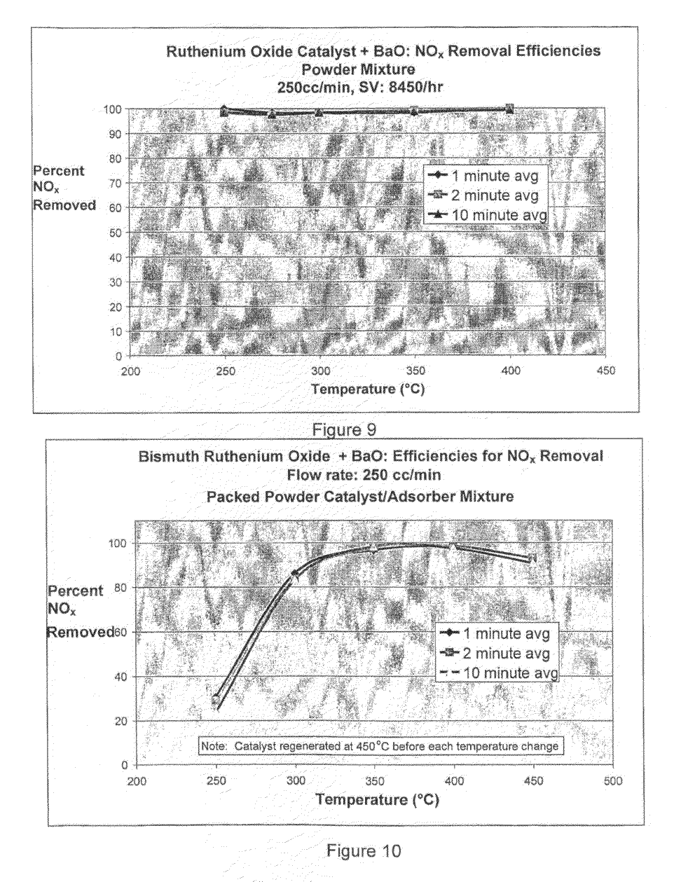

Results from this test with RuO₂ are shown in FIG. 8. The RuO₂ catalyst facilitates the achievement of a high conversion of NO to NO₂ which results in a high removal of NOₓ by the BaO over a period of time. The excellent performance over a wide range of temperature is also demonstrated in FIG. 9 for various time-averaged cycles.

Without being limited to any one theory, it is believed that one potential reason for the improved NOₓ removal efficiency of the catalysts of the present invention at higher temperatures may be that the ruthenium oxide may be partially catalyzing NOₓ decomposition in a manner similar to a lean NOₓ catalyst. FIG. 10 shows that the NOₓ conversion efficiencies of the lower cost catalyst, Bi₂Ru₂O₇ is currently lower than that of RuO₂, but the performance in the temperature range of 300-400° C. is very promising.

### Example 4

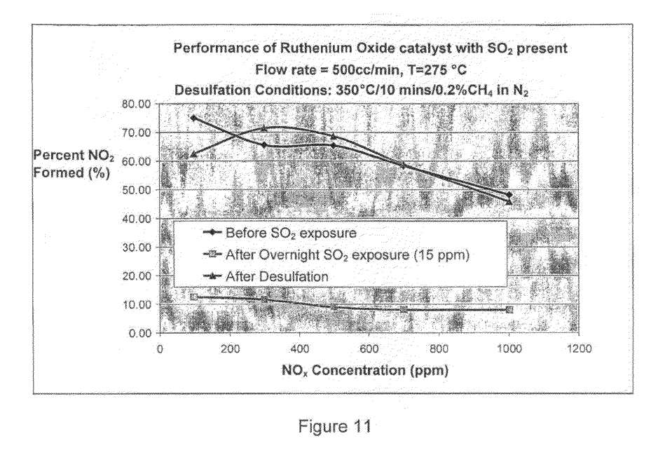

Another feature sought after in catalysts is the ability to recover catalytic performance after exposure to sulfur dioxide. In currently-used catalytic converters, when sulfur dioxide is exposed to the platinum catalyst, sulfur trioxide is formed, poisoning the catalyst and reducing the effectiveness of the system. The ability of the novel catalysts of the present invention to recover from exposure to sulfur dioxide was explored by first exposing the catalyst to sulfur dioxide in a test set up similar to the one described in Example 2. In the experiment, the gas mixture used contained 5% O₂, 15 ppm SO₂, 30 ppm NO, with the balance being N₂, and the gas was exposed to the catalyst system for approximately twelve (12) hours. As seen in the chart provided in FIG. 11, the performance of the catalyst in oxidizing NO to NO₂ deteriorated after the exposure.

After the catalyst was poisoned, the catalyst was subjected to a mild desulfation process. More specifically, in this process, a gas mixture of 0.2% methane (CH₄), with the balance being N₂ was run through the catalyst at 350° C. for 10 minutes. The performance of the catalyst after the desulfation run is also shown in FIG. 11. The results of this experiment demonstrate that the catalyst was approximately fully regenerated after the desulfation procedure.

While specific embodiments of the present invention have been illustrated and described, numerous modifications come to mind without significantly departing from the spirit of the invention, and the scope of protection is only limited by the scope of the accompanying claims.

1. A catalyst for oxidizing nitrogen monoxide (NO) to nitrogen dioxide (NO₂) comprising a ceramic material selected from the group consisting of RuO₂, MnO₂, WO₃, and complex oxides having the formula A₂Ru₂O₇, wherein A is selected from the group consisting of Mg (magnesium), Ca (calcium), Sr (strontium), Ba (barium), Mn (manganese), Ni (nickel), Fe (iron), Co (cobalt), Cu (copper), Ti (titanium), Cr (chromium), Zn (zinc), Nb (niobium), Eu (europium), Ce (cerium), Gd (gadolinium), and Sm (samarium).

2. The catalyst of claim 1, wherein the catalyst comprises a mixture of at least two of the listed ceramic materials.

3. The catalyst of claim 1, wherein the catalyst is a mixture of MnO₂ and WO₃.

4. The catalyst of claim 1, wherein the catalyst further comprises a platinum-group metal.

5. The catalyst of claim 4, wherein the catalyst further comprises platinum.

6. An emission control system comprising:
a catalyst comprising a non-metallic ceramic material selected from the group consisting of RuO₂, MnO₂, WO₃, and complex oxides having the formula A₂Ru₂O₇, wherein A is selected from the group consisting of Mg (magnesium), Ca (calcium), Sr (strontium), Ba (barium), Mn (manganese), Ni (nickel), Fe (iron), Co (cobalt), Cu (copper), Ti (titanium), Cr (chromium), Zn (zinc), Nb (niobium), Eu (europium), Ce (cerium), Gd (gadolinium), and Sm (samarium).

7. The emission control system of claim 6, wherein the catalyst further comprises a platinum-group metal.

8. The emission control system of claim 7, wherein the platinum-group metal is platinum.

9. The emission control system of claim 6, further comprising a NOₓ storage composition for adsorbing NOₓ produced by the catalyst.

10. The emission control system of claim 9, wherein the NOx storage composition is an alkali or an alkaline earth oxide.

11. The emission control system of claim 10, wherein the NOx storage composition is selected from the group consisting of barium oxide, strontium oxide, lithium oxide, and magnesium oxide

12. The emission control system of claim 6, further comprising a catalyst support.

13. The emission control system of claim 12, wherein the support comprises a ceramic structure that serves to increase the surface area of the catalyst.

14. The emission control system of claim 13, wherein the ceramic structure is selected from the group consisting of a three-dimensional channeled structure; a honeycomb structure, γ-alumina powders, γ-alumina pellets, ceria powders, ceria pellets, zirconia powders, and zirconia pellets.

15. A method of oxidizing nitrogen monoxide (NO) gas to nitrogen dioxide (NO₂) gas in a gas flow comprising exposing the gas flow to a ceramic catalyst material selected from the group consisting of RuO₂, MnO₂, WO₃, and complex oxides having the formula A₂Ru₂O₇, wherein A is selected from the group consisting of Mg (magnesium), Ca (calcium); Sr (strontium), Ba (barium), Mn (manganese), Ni (nickel), Fe (iron), Co (cobalt), Cu (copper), Ti (titanium), Cr (chromium), Zn (zinc), Nb (niobium), Eu (europium), Ce (cerium), Gd (gadolinium), and Sm (samarium).

16. The method of claim 15, wherein the catalyst further includes a platinum-group metal.

17. The method of claim 16, wherein the platinum-group metal is platinum.

18. The method of claim 15, wherein the gas flow is an exhaust gas flow produced by the combustion of diesel, petroleum fuel, natural gas, coal, other carbonaceous fuels, or from other chemical processes.

19. The method of claim 15, further comprising the step of exposing the gas flow to a NOₓ storage composition after exposing the gas flow to the ceramic catalyst to cause adsorption of NOₓ produced by the catalyst.

20. The method of claim 19, wherein the NOₓ storage composition is an alkali or an alkaline earth oxide.

21. The emission control system of claim 10, wherein the NOₓ storage composition is selected from the group consisting of barium oxide, strontium oxide, lithium oxide, and magnesium oxide.
